(19) United States
(12) Patent Application Publication
(10) Pub. No.: US 2019/0082894 A1
(43) Pub. Date: Mar. 21, 2019

(54) SPORTS SHAKER CUP

(71) Applicant: Lewis Divinity, Los Angeles, CA (US)

(72) Inventor: Lewis Divinity, Los Angeles, CA (US)

(21) Appl. No.: 15/607,693

(22) Filed: May 30, 2017

(51) Int. Cl. A47J 43/27; B65D 81/38; B65D 43/02; B65D 47/08; B65D 51/24; B65D 51/18; B65D 43/16; B65D 53/02

(52) U.S. Cl. CPC A47J 43/27; B65D 81/3865; B65D 43/02; B65D 47/0857; B65D 51/242; B65D 51/18; B65D 2251/009; B65D 53/02; B65D 2251/0021; B65D 2251/0025; B65D 2251/0028; B65D 2251/0081; B65D 2251/0087; B65D 43/163

(57) ABSTRACT

A sports shaker cup that affords consumers with a sturdy and trendy alternative to conventional sports shaker cups. The sports shaker cup includes a base container that contains a drink that is desired to be consumed, a lid removably secured over the top opening of the base container, the lid includes a drinking spout, a handle and a spout cover, the spout cover includes a fitted plug adapted to cover the drinking spout and prevents the drink from coming out of the drinking spout and debris from coming through the drinking spout and into the drink contained in the base container. The sports shaker cup includes a seal attached underneath the lid and prevents the drink from leaking from the lid and the sports shaker cup, the seal allows the lid to snap on and off of the top opening of the base container.

### BACKGROUND OF THE INVENTION

### Field of the Invention

The present invention is a cup. More specifically, the present invention is a sports shaker cup.

### Description of the Related Art

Shaker containers are popular accessories utilized among athletes, fitness goers, and individuals who prefer having their drinks on-the-go. Moreover, present products available on the market are prone to cracks and leaks due to falls which can hinder functionality. Despite the high demand for these bottle types, the sports shaker cup is a stylish yet durable product that offers an unparalleled resilience that can withstand splits and breakage during transit.

What is needed is a sports shaker cup that afford consumers with a sturdy and trendy alternative to conventional sports shaker cups.

### SUMMARY OF THE INVENTION

The present invention is a cup. More specifically, the present invention is a sports shaker cup.

The sports shaker cup includes a base container that contains a drink that is desired to be consumed, a lid removably secured over the top opening of the base container, the lid includes a drinking spout, a handle and a spout cover, the spout cover includes a fitted plug adapted to cover the drinking spout and prevents the drink from coming out of the drinking spout and debris from coming through the drinking spout and into the drink contained in the base container. The sports shaker cup includes a seal attached underneath the lid and prevents the drink from leaking from the lid and the sports shaker cup, the seal allows the lid to snap on and off of the top opening of the base container.

It is an object of the present invention to provide a sports shaker cup that features a novel seal present underneath the lid which creates a spill-proof design.

It is an object of the present invention to provide a sports shaker cup that includes a wide nozzle with a handle located at the top which affords a comfortable and sturdy grip during movement and/or exercise for maximum utilization.

It is an object of the present invention to provide a sports shaker cup that is made with carbon fiber and other materials for optimal durability.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of a sports shaker cup, in accordance with one embodiment of the present invention.

FIG. 2 illustrates an overhead view of a sports shaker cup, in accordance with one embodiment of the present invention.

FIG. 3 illustrates a side view of a lid, in accordance with one embodiment of the present invention.

FIG. 4 illustrates a cross-sectional side view along Line 1-1 of FIG. 1 of a sports shaker cup, in accordance with one embodiment of the present invention.

FIG. 5 illustrates a top ring strainer, in accordance with one embodiment of the present invention.

FIG. 6 illustrates an overhead view of a top ring strainer and a middle ring strainer, in accordance with one embodiment of the present invention.

FIG. 7 illustrates a side view of a seal, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

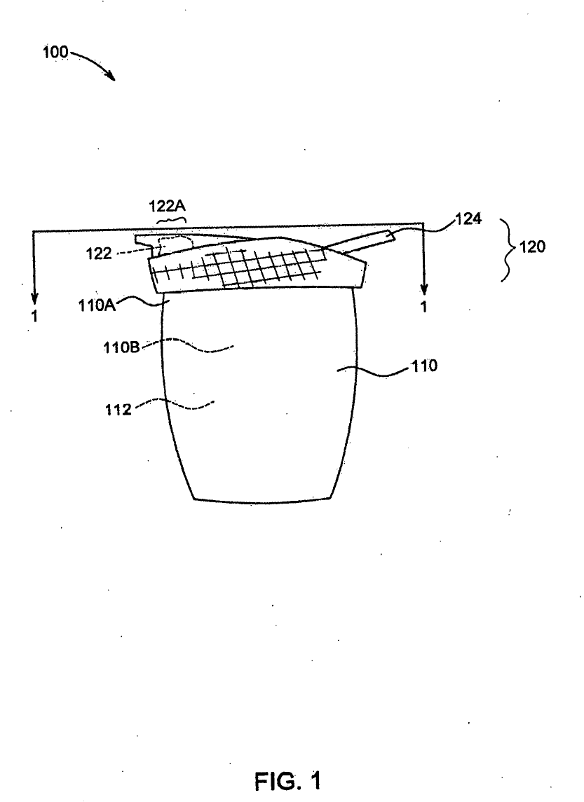

FIG. 1 illustrates a side view of a sports shaker cup 100, in accordance with one embodiment of the present invention.

The sports shaker cup 100 may include a base container 110 and a lid 120.

The base container 110 may have a top opening 110A and an interior 1108. The base container 110 may contain a drink 112 such as a cold beverage, a hot beverage or other suitable beverage that is desired to be consumed. The base container 110 may be insulated to keep the drink hot or cold while contained in the base container 110. The lid 120 may be removably secured over the top opening 110A of the base container 110. The lid 120 may include a drinking spout 122 and a handle 124. The lid 120 may be made of carbon fiber to make the lid 120 lightweight and easy to transport. The drinking spout 122 may have an aperture 122A that a person may drink the drink 112 contained in the base container 110 adapted to flow therethrough top opening 110A of the base container 110 and the aperture 122A. The handle 124 may be pressed-up to help remove the lid 120 from the top opening 110A of the base container 110. The handle 124 may horizontally extend from the lid 120 and allow a person to push-up on the lid 120 and allow the lid 120 to snap on and off of the top opening 110A of the base container 110. The handle 124 may be made of plastic or other suitable material for inexpensive and easy production.

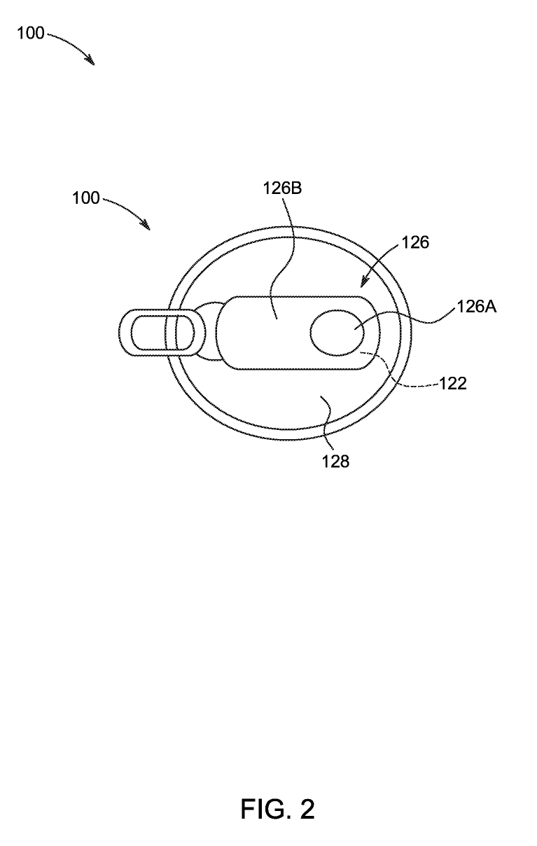

FIG. 2 illustrates an overhead view of a sports shaker cup 100, in accordance with one embodiment of the present invention.

The lid 120 may include a spout cover 126 and a raised top surface 128.

The spout cover 126 may include a fitted plug 126A and an elongated extension 1268. The fitted plug 126A may be adapted to cover the drinking spout 122 and prevent the drink 112 from coming out of the drinking spout 122 and from debris from coming through the drinking spout 122 and into the drink 112 contained in the base container 110. FIG. 2 illustrates the drinking spout 122 and the spout cover 126 of the lid 120 in a closed position. The raised top surface 128 may adapted to allow liquid to run off of the curved top surface 128 and not seep through the lid 120 into the base container 110. The lid 120 may be made of plastic or other suitable material for inexpensive and easy production. The lid 120 may be made of carbon fiber to make the sports shaker cup 100 lightweight and easy to transport.

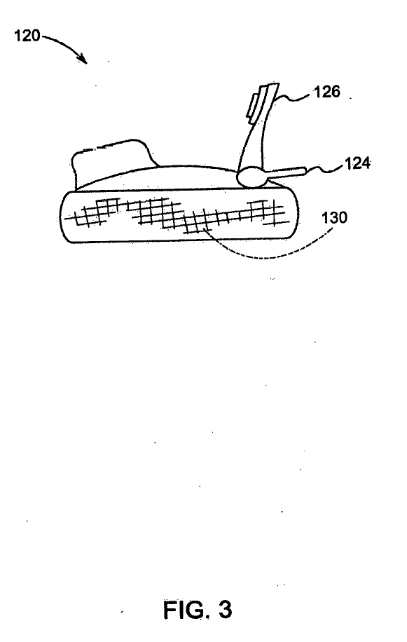

FIG. 3 illustrates a side view of a lid 120 and a seal 130, in accordance with one embodiment of the present invention. FIG. 3 illustrates the drinking spout 122 and the spout cover 126 of the lid 120 in an open position.

The seal 130 may be attached underneath the lid 120 and prevents the drink 112 from leaking from the lid 120 and the sports shaker cup 100. The seal 130 may allow the lid 120 to snap on and off of the top opening 110A of the base container 110, while maintaining an air tight seal between the lid 120 and the top opening 110A of the base container 110. The seal 130 may be made of carbon fiber to prevent cracking and maintain durability. The seal 130 may have a rough textured surface to facilitate grasping the seal 130 and the sports shaker cup 100.

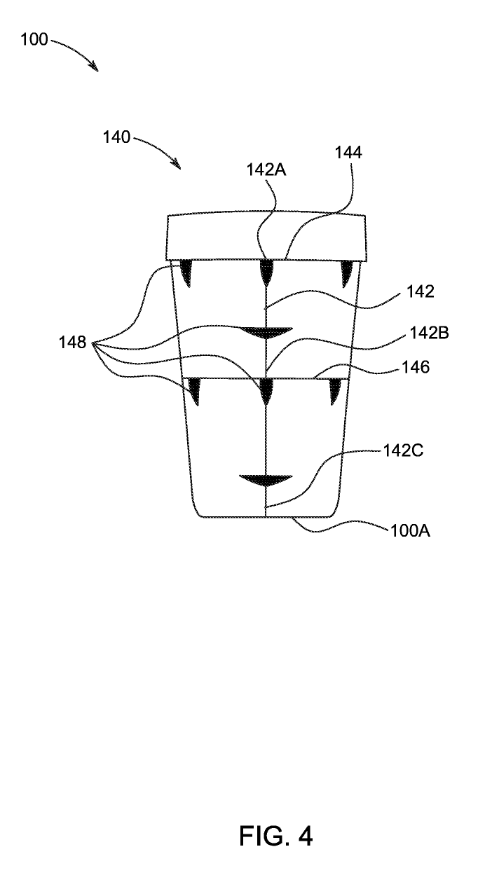

FIG. 4 illustrates a cross-sectional side view along Line 1-1 of FIG. 1 of a sports shaker cup 100, in accordance with one embodiment of the present invention.

The sports shaker cup 100 may include a straining system 140 having a stem 142, a top ring strainer 144, a middle ring strainer 146 and a plurality of blades 148.

The stem 142 may include a first end 142A, a middle portion 142B and a second end 142C. The top ring strainer 144 may be attached to the first end 142A of the stem 142. The middle ring strainer 146 may be attached to the middle portion 142B of the stem 142. The second end 142C may stand on a bottom portion 100A of the sports shaker cup 100. The blades 148 may be disposed on the stem 142, the top ring strainer 144 and the middle ring strainer 146 equidistance from each other to cut any liquid or solid that passes through the top ring strainer 140. The straining system 140 may strain any liquid or solid that passes through the top ring strainer 144.

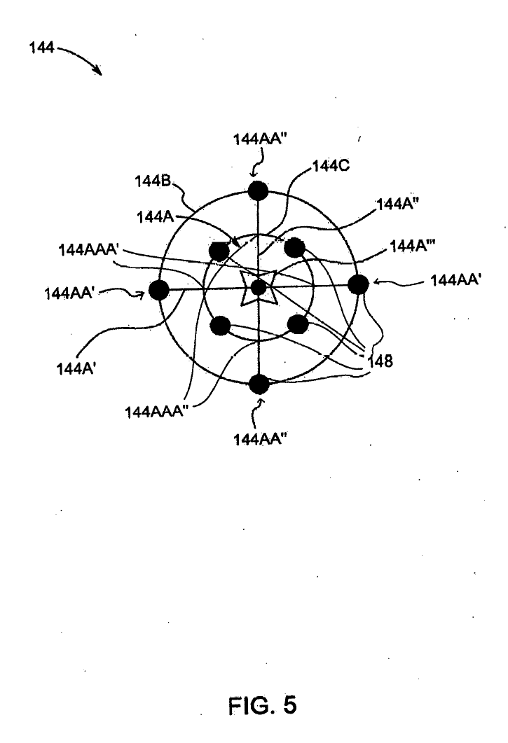

FIG. 5 illustrates an overhead view of a top ring strainer 144, in accordance with one embodiment of the present invention.

The top ring strainer 144 may include a cross-shape linear support 144A, a first linear ring 144B and a second linear ring 144C.

The cross-shape linear support 144A may include a horizontal linear support 144A′, a vertical linear support 144A″ and a center portion 144K″. The first linear ring 144B may be attached to each end 144AA′ of the horizontal linear support 144A′ and attached to each end 144AA″ of the vertical linear support 144A″. The second linear ring 144C may be attached to a middle portion 144AAA′ of the horizontal linear support 144A′ and attached to a middle portion 144AAA″ of the vertical linear support 144A″.

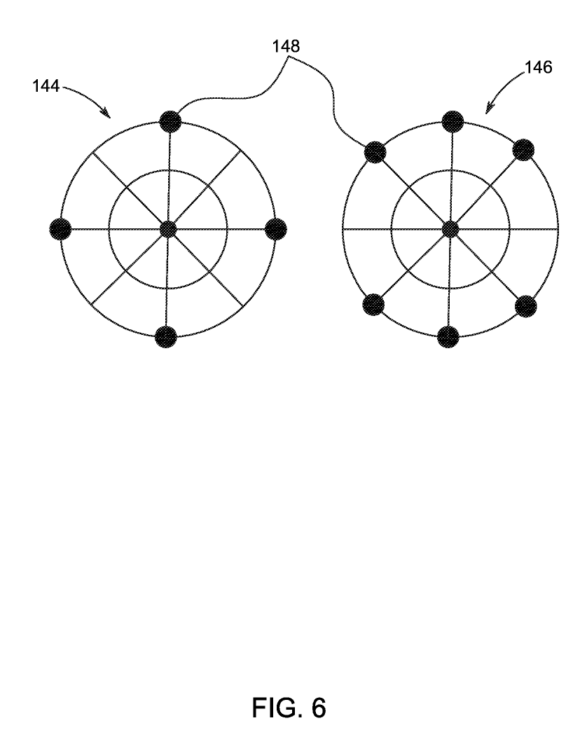

FIG. 6 illustrates an overhead view of a top ring strainer 144 and a middle ring strainer 146, in accordance with one embodiment of the present invention.

The blades 148 disposed on the top ring strainer 144 may be larger than the blades 148 disposed on the middle ring strainer 146 to allow the middle ring strainer 146 to fit into the sports shaker cup (FIG. 1, 100).

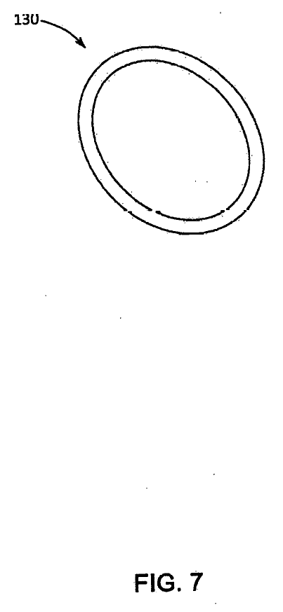

FIG. 7 illustrates a side view of a seal 150, in accordance with one embodiment of the present invention.

The seal 150 may be placed underneath the lid (FIG. 1, 120) to prevent material contain within the sports shaker cup (FIG. 1, 100) from leaking out of the sports shaker cup 100. The seal 150 may be made of carbon fiber, rubber, silicone or other suitable material.

The sports shaker cup is ideal for thick smoothies, shakes and other suitable drinks. The sports shaker cup may easily appeal to all individuals who are looking for a more durable, but cost-effective solution to carrying their protein shakes and beverages, whether hot or cold, with them everywhere they go. The sports shaker cup is essential for fitness enthusiasts as well as the everyday consumers and may be readily available at a wide variety of sports nutrition shops, sporting goods stores, retail department stores, and online retailers.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

1. A sports shaker cup, comprising:
a base container having a top opening and an interior, the base container contains a drink that is desired to be consumed, the base container is insulated to keep the drink hot or cold while contained in the base container;
a lid removably secured over the top opening of the base container, the lid includes a drinking spout, a handle and a spout cover, the drinking spout has an aperture that the person may drink the drink contained in the base container adapted to flow therethrough top opening of the base container and the aperture, the spout cover includes a fitted plug adapted to cover the drinking spout and prevent the drink from coming out of the drinking spout and debris from coming through the drinking spout and into the drink contained in the base container;
a straining system having a stem, a top ring strainer and a middle ring strainer and a plurality of blades, the stem includes a first end, a middle portion and a second end, the top ring strainer is attached to the first end of the stem, the middle ring strainer is attached to the middle portion of the stem, the second end stands on a bottom portion of the sports shaker cup; and
a seal attached underneath the lid and prevents the drink from leaking from the lid and the sports shaker cup, the seal maintains an air tight seal between the lid and the top opening of the base container, and the seal allows the lid to snap on and off of the top opening of the base container.

2. The sports shaker cup according to claim 1, further comprising a raised top surface adapted to allow liquid to run off of the raised top surface and not seep through the lid into the base container.

3. The sports shaker cup according to claim 1, wherein the raised top surface is made of plastic.

4. The sports shaker cup according to claim 1, wherein the drink is a cold beverage or a hot beverage.

5. The sports shaker cup according to claim 1, wherein the lid is made of plastic.

6. The sports shaker cup according to claim 1, wherein the lid is made of carbon fiber.

7. The sports shaker cup according to claim 1, wherein the handle is pressed-up to help remove the lid from the top opening of the base container.

8. The sports shaker cup according to claim 1, wherein the handle is made of plastic.

9. The sports shaker cup according to claim 1, wherein the top ring strainer includes a cross-shape linear support, a first linear ring and a second linear ring.

10. The sports shaker cup according to claim 9, wherein the cross-shape linear support includes a horizontal linear support, a vertical linear support and a center portion.

11. The sports shaker cup according to claim 10, wherein the first linear ring is attached to each end of the horizontal linear support and attached to each end of the vertical linear support, the second linear ring is attached to a middle portion of the horizontal linear support and attached to a middle portion of the vertical linear support.

12. The sports shaker cup according to claim 9, wherein the blades disposed on the top ring strainer are larger than the blades disposed on the middle ring strainer to allow the middle ring strainer to fit into the sports shaker cup.

13. The sports shaker cup according to claim 12, wherein the blades are disposed on the stem, the top ring strainer and the middle ring strainer equidistance from each other to cut any liquid or solid that passes through the top ring strainer.

14. The sports shaker cup according to claim 9, wherein the straining system strains any liquid or solid that passes through the top ring strainer.

15. The sports shaker cup according to claim 1, wherein the seal is made of material selected from the group consisting of carbon fiber, rubber or silicone.

16. The sports shaker cup according to claim 1, wherein the seal has a rough textured surface to facilitate grasping the seal and the sports shaker cup.
